(19) United States
(12) Patent Application Publication
(10) Pub. No.: US 2004/0234367 A1
(43) Pub. Date: Nov. 25, 2004

(54) COMBINATION HOIST AND TRAILER HITCH

(76) Inventor: Timothy W. Pacini, Port Orange, FL (US)

Correspondence Address: J. WILEY HORTON, ESQUIRE, Pennington, Moore, Wilkinson, Bell & Dunbar, P.A., Post Office Box 10095, Tallahassee, FL, 32302-2095, US

(21) Appl. No.: 10/440,771

(22) Filed: May 19, 2003

(51) Int. Cl. B60R 9/00

(52) U.S. Cl. 414/543

(57) ABSTRACT

A modified drawbar and specialized hoist. The modified drawbar fits into the receiver on a truck hitch frame. It simultaneously mounts the hoist and a conventional hitch ball. The hitch ball can receive and tow a trailer while the hoist remains in position for use. The hoist is designed to lift cargo within the bed of the truck, swing it over the side walls of the truck, and set it on the ground. It can also lift cargo off the trailer, swing it to one side, and set it on the ground. The hoist can likewise be employed to lift objects from the ground and place them in the truck's bed or on the trailer.

### CROSS-REFERENCES TO RELATED APPLICATIONS

Not Applicable.

### STATEMENT REGARDING FEDERALLY SPONSORED RESEARCH OR DEVELOPMENT

Not Applicable.

### MICROFICHE APPENDIX

Not Applicable

### BACKGROUND OF THE INVENTION

1. Field of the Invention

This invention relates to the field of trailer hitches and hoists. More specifically, the invention comprises a trailer hitch with features for mounting a hoist which can be employed to load and unload cargo from a truck or trailer while the trailer is attached to the truck.

2. Description of the Related Art

Hoists incorporating an upright mast with swiveling boom have been in common use for many years. Recently, such hoists have been adopted for use with hitch mounting features found on many trucks. FIG. 1 shows truck 10 incorporating hitch frame 12. Hitch frame 12 includes a rectangular cavity designated as receiver 14. Drawbar 16 slides into receiver 14, where it is typically locked in place by crosspin 60. Drawbar 16 mounts hitch ball 18, which is used to attach and tow a trailer.

Prior art hoists have been attached to truck 10 by removing drawbar 16 and substituting the base member of the hoist in its place. Thus, the hoists are attached directly to hitch frame 12, which possesses considerable strength. While this approach has been successful, it eliminates the hitch ball—meaning that when the hoist is in use a trailer cannot be connected to the truck.

### BRIEF SUMMARY OF THE PRESENT INVENTION

The present invention comprises a modified drawbar and specialized hoist. The modified drawbar fits into the receiver on a truck hitch frame. It simultaneously mounts the hoist and a conventional hitch ball. The hitch ball can attach and tow a trailer while the hoist remains in position for use. The hoist is designed to lift cargo within the bed of the truck, swing it over the side walls of the truck, and set it on the ground. It can also lift cargo off the trailer, swing it to one side, and set it on the ground. The hoist can likewise be employed to lift objects from the ground and place them in the truck's bed or on the trailer.

### BRIEF DESCRIPTION OF THE SEVERAL VIEWS OF THE DRAWINGS

FIG. 1 is a perspective view, showing a prior art trailer hitch assembly.

FIG. 2 is a perspective view, showing a modified drawbar.

FIG. 3 is a perspective view, showing a hoist.

FIG. 4 is a perspective view, showing the installation of the modified drawbar and the hoist

FIG. 5 is a perspective view, showing the modified drawbar and the hoist in the installed

FIG. 6 is a perspective view, showing a truck with the hoist and a trailer attached.

FIG. 6B is a detail view, showing locking features on the hoist.

FIG. 7 is a perspective view, showing the hoist in operation.

FIG. 8 is a perspective view, showing the hoist in operation.

FIG. 9 is an exploded perspective view, showing an alternate method for mounting the mast.

FIG. 10 is a perspective view, showing the alternate mast in place.

### REFERENCE NUMERALS IN THE DRAWINGS

| | | | |
|---|---|---|---|
| 10 | truck | 12 | bitch frame |
| 14 | receiver | 16 | drawbar |
| 18 | hitch ball | 20 | modified drawbar |
| 22 | main beam | 24 | column |
| 26 | front brace | 28 | rear brace |
| 30 | ball mount | 32 | loading flange |
| 34 | hoist receiver | 36 | hoist |
| 38 | mast | 40 | boom |
| 42 | hydraulic cylinder | 44 | hoisting hook |
| 46 | pivot joint | 48 | cylinder anchor |
| 50 | base | 52 | swivel pin |
| 54 | trailer | 56 | cargo |
| 58 | truck bed | 60 | cross pin |
| 62 | side wall | 64 | lock pin |
| 66 | bore | 68 | cross pin hole |
| 70 | hollow cylinder | 72 | pivot shall |
| 74 | friction bolt | | |

### DESCRIPTION OF THE INVENTION

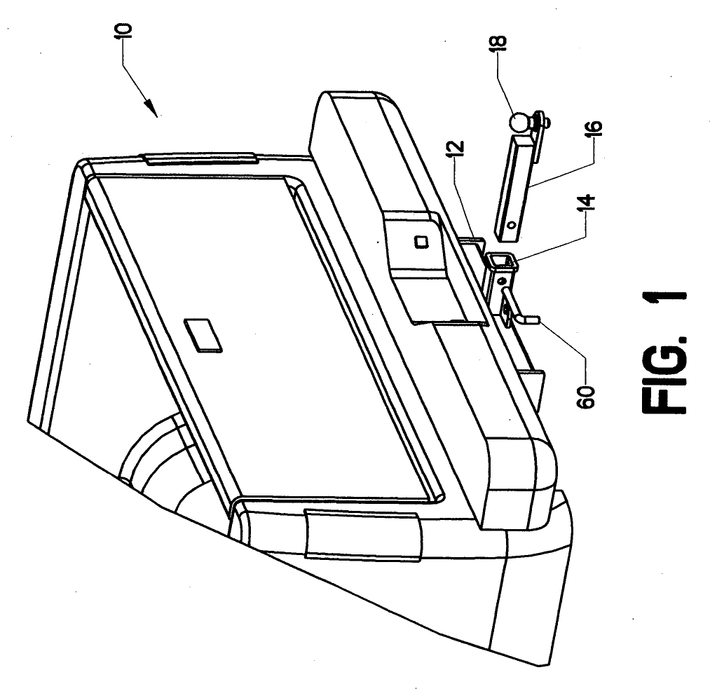

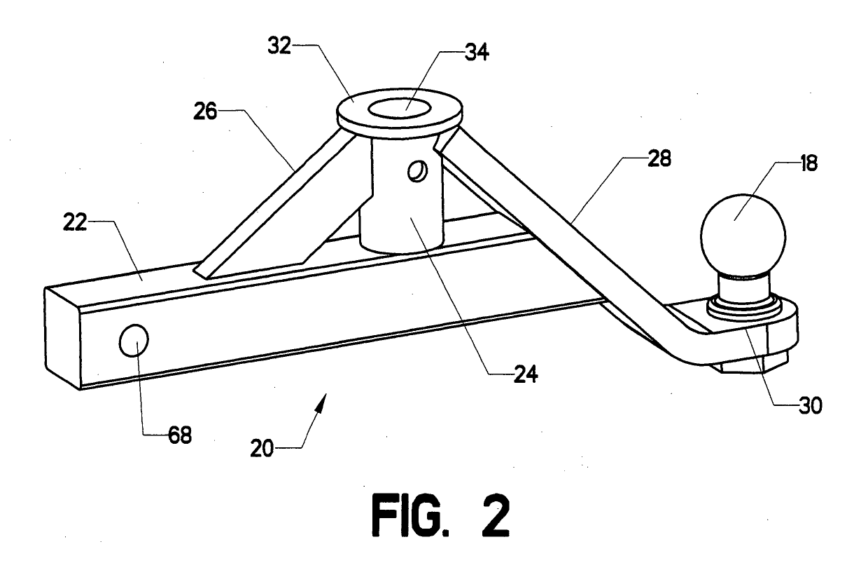

FIG. 1 shows a conventional draw bar 16. While prior art drawbars come in many variations, they gererally have a square portion designed to fit within receiver 14,and a provision for mounting hitch ball 18. FIG. 2 illustrates modified drawbar 20, which is intended to replace conventional draw bar 16 in the present invention. Main beam 22 is the primary structural element. It has a first end shaped to slide within receiver 14. This portion is pierced by cross pin hole 68, which is sized to admit the passage of a cross pin 60 in order to lock modified drawbar 20 within receiver 14. The second end of main beam 22 is attached to ball mount 30, which mounts a prior art hitch ball 18.

Column 24 is mounted on the middle of main beam 22. Its upper extreme opens into hoist receiver 34—a vertically-oriented cylindrical opening. This opening extends downward substantially through the entire height of column 24. Loading flange 32 surrounds the opening of hoist receiver 34. Front brace 26 and rear brace 28 are added to strengthen the overall structure of modified drawbar 20. Modified drawbar 20 could be cast, but it is preferably made as a weldment of the basic components illustrated.

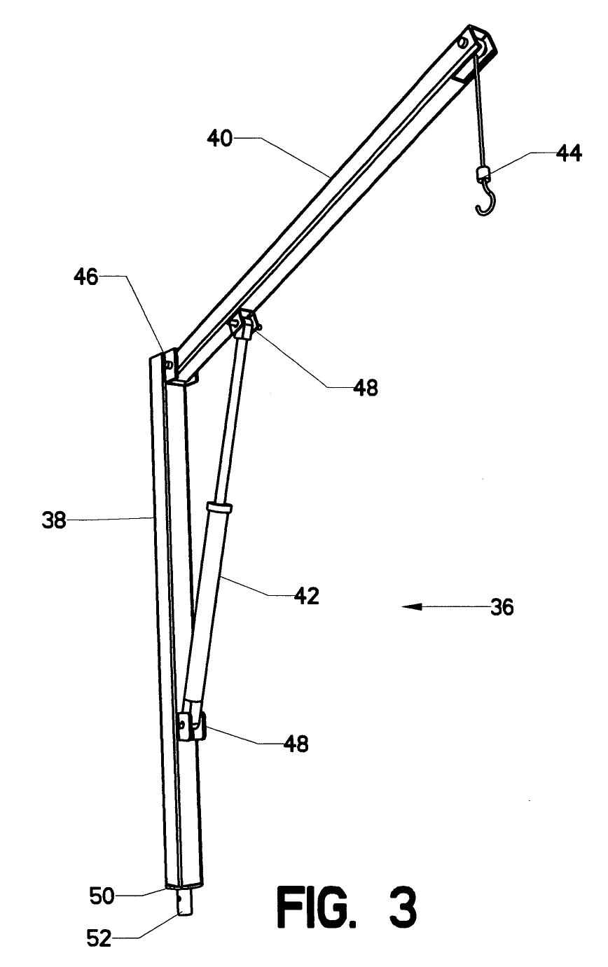

FIG. 3 illustrates hoist 36. Its two major component are mast 38 and boom 40. Base 50 and swivel pin 52 are affixed to the bottom of mast 38. Boom 40 is pivotally attached to mast 38 at pivot joint 46. The distal end of boom 40 mounts hoisting hook 44 (usually attached via a wire rope or a chain). Hydraulic cylinder 42 is mounted between mast 38 and boom 40 using pin joints designated as cylinder anchors 48. Hydraulic cylinder 42 extends and retracts in response to user control. It thereby causes boom 40 to pivot upward or downward with respect to mast 38. Hydraulic pressure can be provided using a variety of means, including a hand pump or an electric pump powered by the truck's electrical system.

Those skilled in the art will realize that the components shown in FIG. 3 are conventional. Those skilled in the art will also realize that many other conventional components could be substituted for those illustrated. As an example, a cable winch can be substituted for the hydraulic cylinder. In such an embodiment, the winch would be used to raise and lower boom 40. It is also possible to combine a winch and hydraulic cylinder, whereby the hydraulic cylinder raises and lowers boom 40 and the winch extends and retracts hoisting hook 44. These variations, as well as many others, could be employed in the present invention.

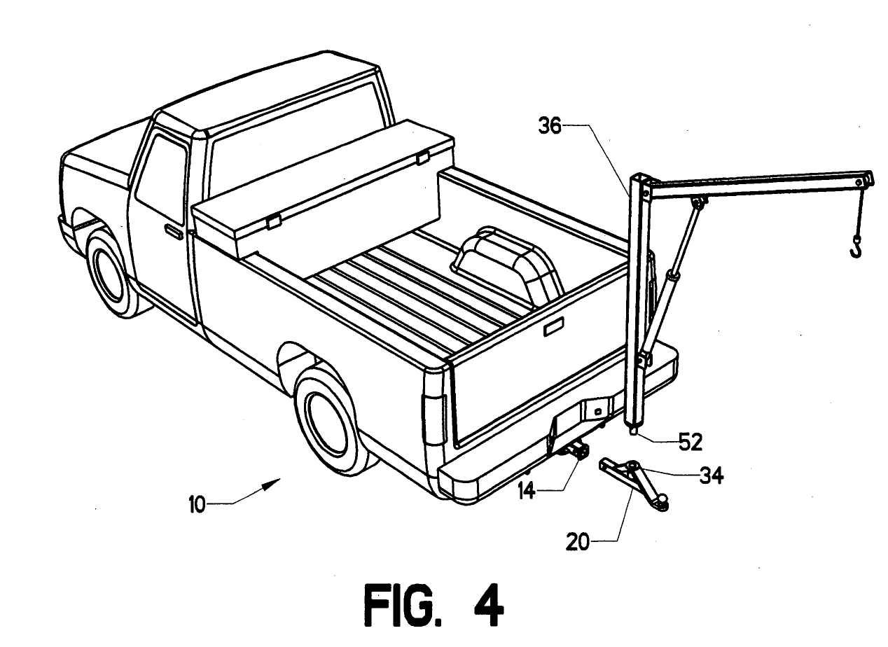

FIG. 4 shows the installation of the device. Modified drawbar 20 is placed in receiver 14 (and preferably locked in place using a cross pin, bolt, or similar means). Hoist 36 is then attached to modified drawbar 20 by lowering swivel pin 52 into hoist receiver 34. Looking at FIGS. 2 and 3, the reader will observe that swivel pin 52 is a close sliding fit within hoist receiver 34. Base 50 and loading flange 32 combine to form a thrust bearing; i.e., the weight of hoist 36 is transmitted to loading flange 32 by base 50.

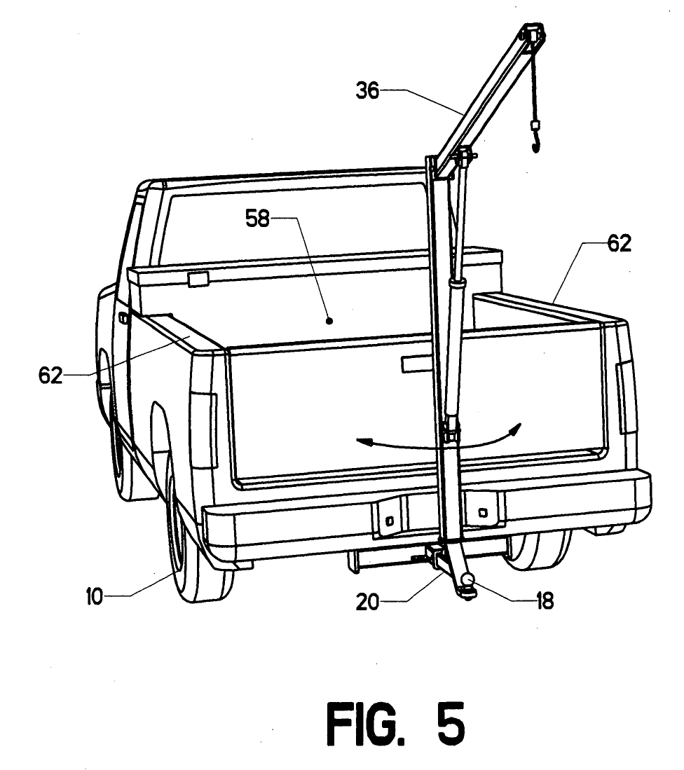

FIG. 5 shows modified drawbar 20 and hoist 36 installed on truck 10. The interaction of swivel pin 52 and hoist receiver 34 allows hoist 36 to swivel as indicated by the reciprocating arrow. As described previously, boom 40 can be raised and lowered as desired. This combination of motion allows hoist 36 to lift objects out of truck bed 58 over side walls 62.

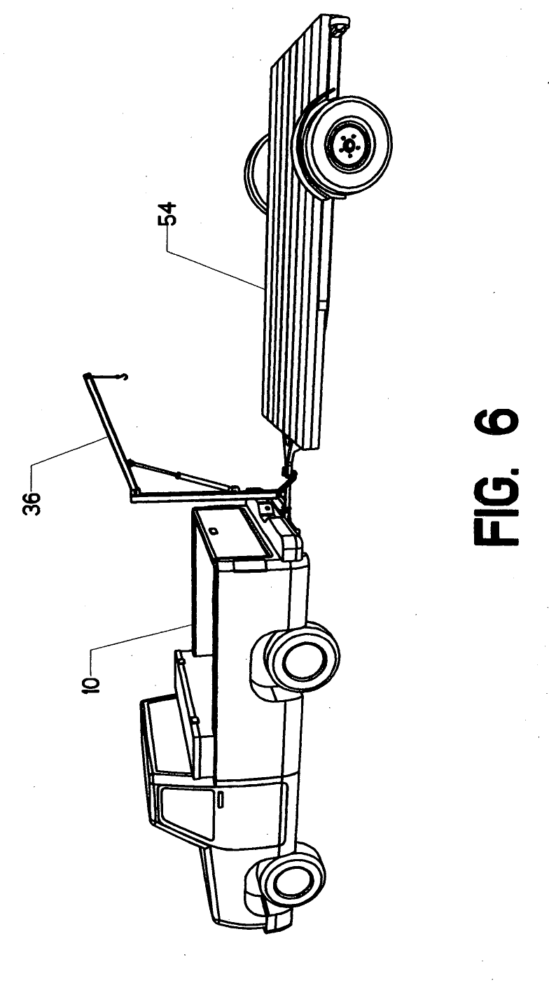

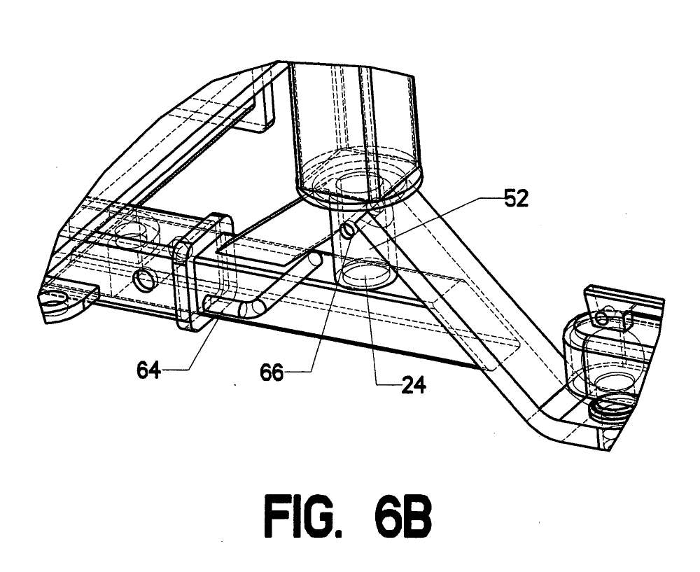

Hitch ball 18 is positioned far enough to the rear of hoist 36 to allow the attachment of a towed object such as a trailer. FIG. 6 shows truck 10 with trailer 54 attached. Hoist 36 is shown in position and ready for use. Securing features can be provided on hoist 36 which allow it to safely remain in position while truck 10 is proceeding down the highway. FIG. 6B is a detailed hidden line view of swivel pin 52 resting within column 24. Both swivel pin 52 and column 24 are pierced by a transverse bore 66. When the two components of bore 66 are aligned, lock pin 64 can be inserted therein. Hoist 36 is thereby restrained from pivoting and from lifting free of modified drawbar 20. This locking feature allows safe transport of the installed hoist.

Although the features just described allow hoist 36 to be transported in place, the user may not wish to do so. Hydraulic cylinder 42 and boom 40 can be easily removed from mast 38 by providing removable pins at pivot joint 46 and cylinder anchors 48. Mast 38 can then be removed from modified drawbar 20 by lifting it free. Thus, all the components of hoist 36 can be removed and placed in the bed of truck 10 (or some other convenient location).

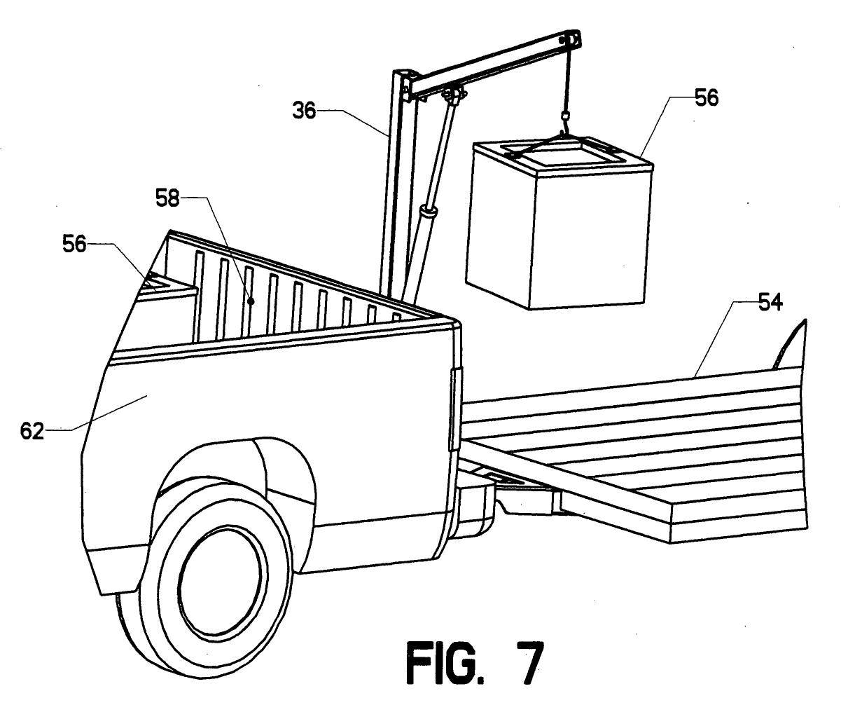

The operation of hoist 36 will now be described. FIG. 6 shows the invention ready for use, with trailer 54 still attached to truck 10. In FIG. 7, hoist 36 is being used to lift cargo 56 up from truck bed 58, swing it laterally over side wall 62, and deposit it on the ground or on an adjacent structure such as a loading dock. This action can be performed while trailer 54 remains attached.

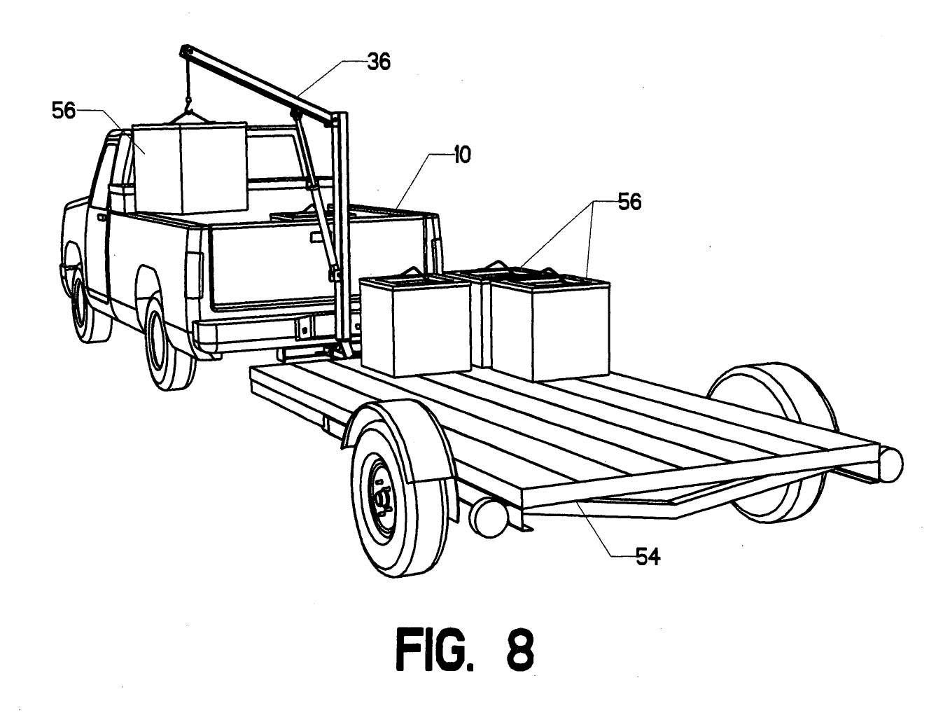

Likewise, FIG. 8 demonstrates how hoist 36 can be used to lift cargo 56 off of trailer 54, swing it laterally, and place it on the ground or adjacent structure. The reverse is obviously true-hoist 36 can be used to lift cargo from the ground and place it in the truck bed or on the trailer. Hoist 36 can even be used to transfer cargo from the truck to the trailer or vice-versa.

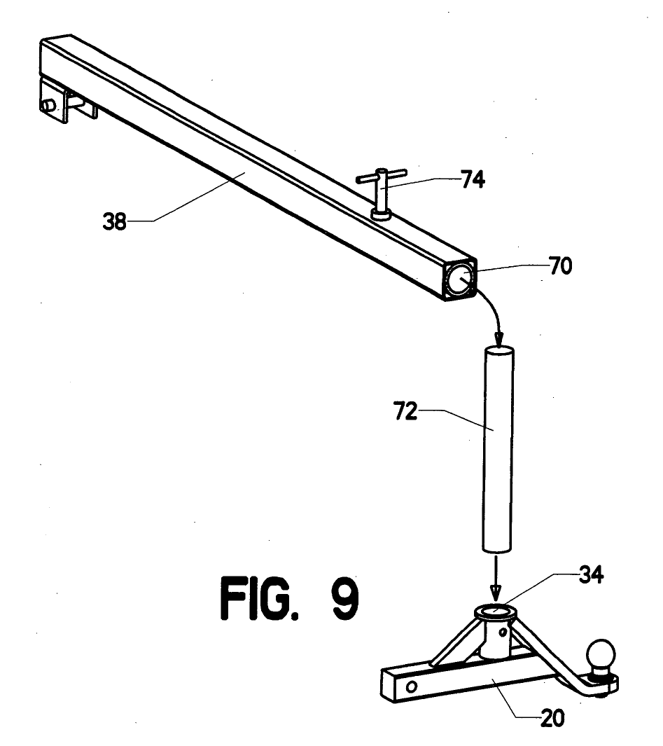

Numerous types of mechanisms can be employed to mount the hoist assembly to the modified drawbar. FIG. 9 shows one such alternative. The particular mast 38 shown is not equipped with base 50 and swivel pin 52. Instead, hollow cylinder 70 is welded inside the square tube structure of mast 38. Pivot shaft 72 is placed into hoist receiver 34, where it is secured in place via welds, bolts, a cross pin, or other common method. Once pivot shaft 72 is secured, hollow cylinder 70 is slipped over pivot shaft 72. Mast 38 is then free to rotate on pivot shaft 72.

Friction bolt 74 is preferably added to control rotation of this embodiment. This feature consists of a bolt threaded into a boss on mast 38. The leading end of friction bolt 74 extends into hollow cylinder 70. When mast 38 is in position on pivot shaft 72, turning friction bolt 74 in a clockwise direction (A tee handle is provided for this purpose) advance it further into mast 38, bringing its inward extremity against pivot shaft 72. If the user then tightens friction bolt 74, mast 38 will be rotationally locked to pivot shaft 72.

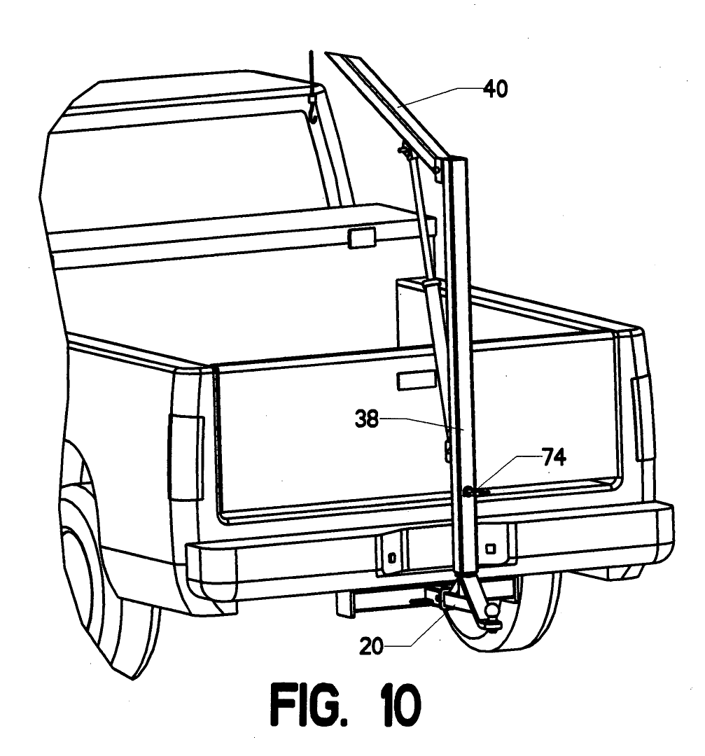

FIG. 10 shows the alternate embodiment installed on a truck. The reader will observe that friction bolt 74 is readily accessible to the user. It can be tightened to rotationally lock mast 38 when the mast is in any orientation.

Although simple crates have been used to illustrate the cargo, the reader should be aware that hoist 36 can be used to move virtually any type of object. As one example, truck 10 might be towing a boat and transporting a personal water craft (“PWC”) in its bed. The present invention allows the PWC to be swung over the side and lowered into the water while the boat and trailer remain attached to the truck.

Although the preceding descriptions contain significant detail they should not be viewed as limiting the invention but rather as providing examples of the preferred embodiments of the invention. Accordingly, the scope of the invention should be determined by the following claims, rather than the examples given.

Having described my invention, I claim:

1. A hoist for use with cargo to be transported in a load-carrying vehicle or a trailer, wherein said load-carrying vehicle includes a receiver for receiving a conventional hitch drawbar, comprising:
a. a modified drawbar including
i. a main beam configured to be slidably received within said receiver;
ii. hoist attaching means affixed to said main beam; and
iii. a hitch ball affixed to said main beam for attaching said trailer;
b. a hoist including
i. a mast, having an upper end and a lower end, wherein said lower end is pivotally attached to said hoist attaching means on said modified drawbar; and
ii. a boom, having a proximal end and a distal end, wherein said proximal end is attached to said upper end of said mast; and
C. whereby said hoist can be used to load or unload said cargo from said vehicle or said trailer while said trailer is attached to said vehicle.

2. A hoist as recited in claim 1, wherein said hoist attaching means comprises a cylindrical hoist receiver, and wherein said lower end of said mast includes a swivel pin which is pivotally mounted within said hoist receiver.

3. A hoist as recited in claim 1, wherein said attachment between said proximal end of said boom and said upper end of said mast assumes the form of a pivot joint, thereby allowing said boom to pivot up and down with respect to said mast.

4. A hoist as recited in claim 3, further comprising a hydraulic cylinder, having a first end and a second end, wherein said first end is pivotally attached to said mast and said second end is pivotally attached to said boom so that when said hydraulic cylinder extends, said boom will be raised.

5. A hoist for use with cargo to be transported in a load-carrying vehicle or a trailer, wherein said load-carrying vehicle includes a receiver for receiving a conventional hitch drawbar, comprising:
a. a modified drawbar including a first end, a middle portion, and a second end distal to said first end;
b. wherein said first end of said modified drawbar is configured to be slidably received within said receiver;
C. hoist attaching means affixed to said middle portion of said modified drawbar;
d. a hitch ball attached to said second end of said modified draw bar;
e. a mast, having an upper end and a lower end, wherein said lower end is pivotally attached to said hoist attaching means on said modified drawbar; and
f. a boom, having a proximal end and a distal end, wherein said proximal end is attached to said upper end of said mast, so that said hoist can be used to load or unload said cargo from said vehicle or said trailer while said trailer is attached to said vehicle.

6. A hoist as recited in claim 5, wherein said hoist attaching means comprises a cylindrical hoist receiver, and wherein said lower end of said mast includes a swivel pin which is pivotally mounted within said hoist receiver.

7. A hoist as recited in claim 5, wherein said attachment between said proximal end of said boom and said upper end of said mast assumes the form of a pivot joint, thereby allowing said boom to pivot up and down with respect to said mast.

8. A hoist as recited in claim 7, further comprising a hydraulic cylinder, having a first end and a second end, wherein said first end is pivotally attached to said mast and said second end is pivotally attached to said boom so that when said hydraulic cylinder extends, said boom will be raised.

9. A hoist as recited in claim 1, wherein said hoist attaching means comprises:
a. a hoist receiver;
b. a cylindrical pivot shaft located in said hoist receiver and extending upward therefrom; and
c. wherein said lower end of said mast opens into a hollow cylinder sized to slip over said pivot shaft so that said mast rotates on said pivot shaft.

10. A hoist as recited in claim 9, wherein said mast further comprises a friction bolt allowing said mast to be rotationally locked to said pivot shaft.

11. A hoist as recited in claim 5, wherein said hoist attaching means comprises:
a. a hoist receiver;
b. a cylindrical pivot shaft located in said hoist receiver and extending upward therefrom; and
C. wherein said lower end of said mast opens into a hollow cylinder sized to slip over said pivot shaft so that said mast rotates on said pivot shaft.

12. A hoist as recited in claim 5, wherein said mast further comprises a friction bolt allowing said mast to be rotationally locked to said pivot shaft.
